(19) United States
(12) Patent Application Publication
(10) Pub. No.: US 2018/0047153 A1
(43) Pub. Date: Feb. 15, 2018

(54) METHOD AND DEVICE FOR DETECTING HILLOCK IN METAL LAYER

(71) Applicants: BOE Technology Group Co., Ltd., Beijing (CN); Hefei BOE Optoelectronics Technology Co., Ltd., Anhui (CN)

(72) Inventors: Liang XIAO, Beijing (CN); Xunze ZHANG, Beijing (CN); Sangsoo PARK, Beijing (CN)

(21) Appl. No.: 15/673,459

(22) Filed: Aug. 10, 2017

(30) Foreign Application Priority Data
Aug. 12, 2016 (CN) 201610665646.0

(51) Int. Cl. G06T 7/00; G06T 3/40; G06T 5/00

(52) U.S. Cl. CPC G06T 7/0008; G06T 5/007; G06T 3/40; G06T 2207/30136; G06T 2207/30242; G06T 2207/10024

(57) ABSTRACT

The disclosure provides a method and a device for detecting a hillock in a metal layer, belongs to the technical field of hillock detection, and can solve the problem that the existing method for detecting a hillock in a metal layer is complicated, has low efficiency, and can hardly be used in actual production. The method for detecting a hillock in a metal layer in the present disclosure includes: collecting an optical image of the metal layer; adjusting contrast and brightness of the optical image; converting the adjusted optical image into a black-and-white image; and determining a black pixel in the black-and-white image as a spot of a corresponding hillock.

### CROSS-REFERENCE TO RELATED APPLICATION

This application claims priority benefit from Chinese Application No. 201610665646.0, filed to State Intellectual Property Office of the People's Republic of China on Aug. 12, 2016, the content of which is hereby incorporated by reference by its entirety.

### TECHNICAL FIELD

The present disclosure belongs to the technical field of hillock detection, and particularly relates to a method and a device for detecting a hillock in a metal layer.

### BACKGROUND

In a display substrate (e.g., an array substrate) of a display device (e.g., a liquid crystal display device, an organic light emitting diode display device, etc.), pure aluminum may be used to make structures such as wires (e.g., a gate line, a data line, a common electrode line, etc.), electrodes (e.g., a gate electrode, a source electrode, a drain electrode, etc.), and the like. As compared to a conventional alloy material of niobium, molybdenum, etc., pure aluminum has advantages such as low resistivity, low cost, ability to be easily etched, and the like. However, the thermal expansion coefficient of the pure aluminum material differs greatly from that of a glass substrate of the display substrate, resulting in that there may be many protrusions called “hillocks” in the pure aluminum layer. If the hillock problem is too severe, hillocks may penetrate through an insulation layer above the hillocks, causing problems such as breakage in the insulation layer, short circuits among different wires, and the like. For this reason, accurate detection of hillocks in the metal layer is of great importance for ensuring product quality, determining the cause of occurrence of hillocks, reducing the possibility of occurrence of hillocks, etc.

The existing methods for observing and recognizing hillocks are generally complicated, time-consuming, and high in cost, and are not beneficial to prevention and control of hillocks in the actual production process.

### SUMMARY

In order to at least partially solve the problem that the existing method for detecting a hillock in a metal layer is complicated, has low efficiency, and can hardly be used in actual production, the present disclosure provides a method and a device for detecting a hillock in a metal layer, which are simple, easy to implement and efficient.

The technical solutions adopted to solve the technical problem of the present disclosure include a method for detecting a hillock in a metal layer, including:

collecting an optical image of the metal layer;

adjusting contrast and brightness of the optical image to obtain an adjusted optical image;

converting the adjusted optical image into a black-and-white image; and

determining a black pixel in the black-and-white image as a spot of a corresponding hillock.

Optionally, the metal layer is a layer formed of a pure metal.

Further optionally, the layer formed of a pure metal is a pure aluminum layer.

Further optionally, the layer formed of a pure metal is a pure copper layer.

Optionally, the optical image is an enlarged optical image.

Further optionally, the enlarged optical image is collected by a Micro-Macro defect checker.

Optionally, the step of adjusting contrast and brightness of the optical image includes: increasing the contrast and brightness of the optical image.

Optionally, the step of adjusting contrast and brightness of the optical image includes: adjusting the contrast of the optical image according to a predetermined contrast adjustment value; and adjusting the brightness of the optical image according to a predetermined brightness adjustment value.

Optionally, after the step of converting the adjusted optical image into the black-and-white image, the method further includes: determining whether the black pixel in the black-and-white image corresponds to a hillock in the optical image, and if it is determined that the black pixel in the black-and-white image does not correspond to a hillock in the optical image, returning to the step of adjusting contrast and brightness of the optical image.

Optionally, the method further includes: calculating a ratio of the number of black pixels to a total number of pixels in the black-and-white image, and determining hillock condition in the metal layer based on the ratio.

The technical solutions adopted to solve the technical problem of the present disclosure further include a device for detecting a hillock in a metal layer, including:

a collector, configured to collect an optical image of the metal layer;

an adjuster, configured to adjust contrast and brightness of the optical image to obtain an adjusted optical image;

a converter, configured to convert the adjusted optical image into a black-and-white image to obtain an adjusted optical image; and

an analyzer, configured to determine a black pixel in the black-and-white image as a spot of a corresponding hillock.

Optionally, the adjuster is configured to increase the contrast and brightness of the optical image.

Optionally, the adjuster is configured to:

adjust the contrast of the optical image according to a predetermined contrast adjustment value; and

adjust the brightness of the optical image according to a predetermined brightness adjustment value.

Optionally, the analyzer is further configured to calculate a ratio of the number of black pixels to a total number of pixels in the black-and-white image, and determine hillock condition in the metal layer based on the ratio.

In the method for detecting a hillock in a metal layer of the present disclosure, hillock condition in the metal layer can be acquired only by performing simple analysis processing on the optical image, without complicated operations such as substrate slicing, transparent paper labeling, scanning and the like. Thus, the method for detecting a hillock in a metal layer of the present disclosure has high efficiency, generally takes only several hours to be finished, and can be used in the actual production process.

### BRIEF DESCRIPTION OF THE FIGURES

FIG. 1 is a schematic flowchart of a method for detecting a hillock in a metal layer according to embodiments of the present disclosure.

FIG. 2 illustrates an example of an optical image collected in a method for detecting a hillock in a metal layer according to embodiments of the present disclosure.

FIG. 3 is an optical image obtained by adjusting brightness and contrast of the optical image in FIG. 2.

FIG. 4 is a black-and-white image obtained by converting the optical image in FIG. 3.

### DETAILED DESCRIPTION

To make those skilled in the art better understand the technical solutions of the present disclosure, the present disclosure will be further described in detail below in conjunction with the accompanying drawings and specific implementations.

Embodiments of the present disclosure provide a method for detecting a hillock in a metal layer, including:

collecting an optical image of the metal layer;

adjusting contrast and brightness of the optical image;

converting the adjusted optical image into a black-and-white image; and

determining a black pixel in the black-and-white image as a spot of a corresponding hillock.

In the method for detecting a hillock in a metal layer in the embodiments, hillock condition in the metal layer can be acquired only by performing simple analysis processing on the optical image, without complex operations such as substrate slicing, transparent paper labeling, scanning and the like. Thus, the method has high efficiency, takes only several hours to be finished, and can be used in the actual production process.

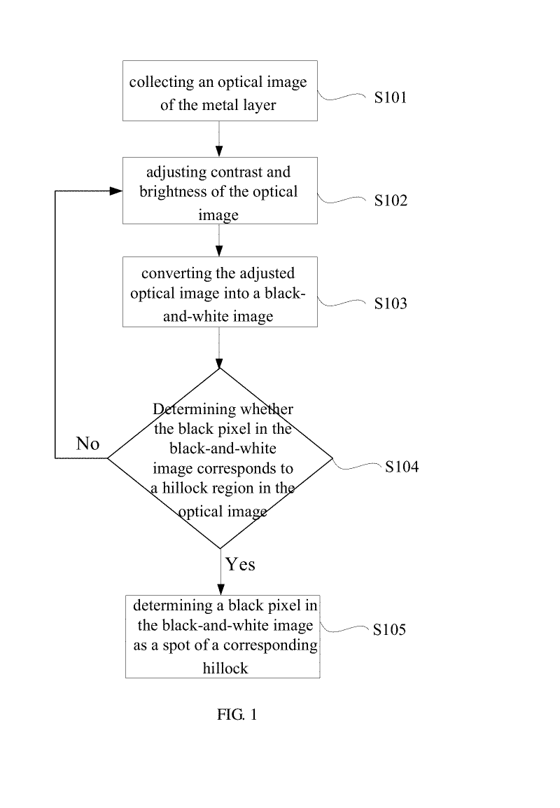

Now, the method for detecting a hillock in a metal layer provided in the embodiments of the present disclosure is described with reference to FIGS. 1 to 4. The method for detecting a hillock in a metal layer is used for detecting the metal layer in a display substrate, to determine hillock condition in the metal layer.

In some embodiments, the display substrate may be an array substrate or the like, and may be used in a display device such as a liquid crystal display device, an organic light emitting diode display device, or the like.

The metal layer used herein refers to a layer formed of a metal or alloy in the display substrate, which may be a complete layer which is not etched after deposition, or a specific structure formed by etching the complete layer, such as wires (e.g., a gate line, a data line, a common electrode line, etc.), electrodes (e.g., a source electrode, a drain electrode, and a gate electrode), or the like.

Optionally, the metal layer to be detected is a layer formed of a pure metal. In some embodiments, the metal layer to be detected is a pure aluminum layer or a pure copper layer.

In general, an alloy made of a variety of metals may have a thermal expansion coefficient close to that of a glass substrate through component design, in order to avoid generation of hillocks. Hence, the hillock problem is generally more prominent in the pure metal layer whose expansion rate is fixed. In the pure metal layer, mainly the pure aluminum layer and the pure copper layer (particularly, the pure aluminum layer) are widely used in the display substrate and have serious hillock problem. Thus, the method provided in the embodiments of the present disclosure is preferably used for detecting a pure aluminum layer and a pure copper layer.

As shown in FIG. 1, specifically, the method for detecting a hillock in a metal layer provided in the embodiments of the present disclosure includes steps S101, S102, S103 and S105.

Step S101 includes collecting an optical image of the metal layer.

In some embodiments, step S101 includes collecting an optical image of the metal layer to be detected and storing the optical image in a predetermined format.

In the case of detecting a plurality of display substrates of a same structure, step S101 may include collecting optical images of the respective display substrates at a same position, to improve the comparability of detection results and allow the device for collecting images not to be moved, thereby facilitating implementation.

Optionally, the optical image is an enlarged optical image. In some embodiments, the enlarged optical image is collected by a Micro-Macro defect checker.

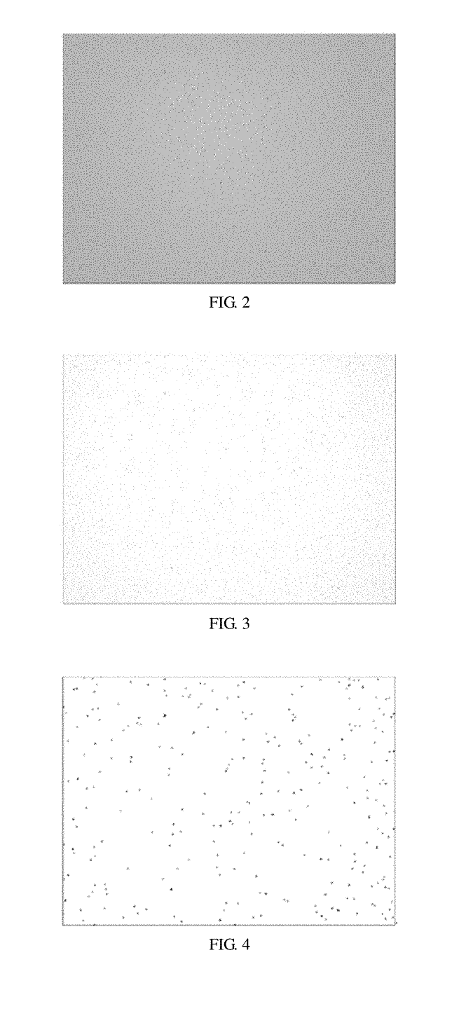

In other words, the existing Micro-Macro defect checker (MM for short) in the production line may be used as the collection device for directly collecting the enlarged optical image of the metal layer. For example, FIG. 2 illustrates one image, magnified 100 times, of a pure aluminum layer collected by the Micro-Macro defect checker.

Because a hillock generally has a very small size, collection of an enlarged image allows more accurate detection and analysis of the hillock. The Micro-Macro defect checker is an existing device in a conventional display substrate production line, and collecting the optical image of the metal layer using the Micro-Macro defect checker is easy to implement and has high efficiency.

Needless to say, it is also feasible to adopt another device such as a camera, a microscope, or the like, which is additionally provided, to collect the above optical image.

Step S102 includes adjusting contrast and brightness of the optical image. In some embodiments, the brightness and contrast of the optical image are adjusted through the MATLAB or other software, so that differences between areas of the hillocks and areas of normal surface of the metal layer in the optical image become more obvious.

Optionally, the adjusting in step S102 is increasing the contrast and brightness of the optical image.

In general, by increasing the contrast and brightness of the optical image, differences between areas of the hillocks and areas of normal surface of the metal layer in the optical image may become more obvious. For example, FIG. 3 is an optical image obtained by increasing brightness and contrast of the optical image in FIG. 2.

Optionally, step S102 is: adjusting the contrast of the optical image according to a predetermined contrast adjustment value; and adjusting the brightness of the optical image according to a predetermined brightness adjustment value.

Obviously, in cases where material of the metal layer, ambient light, an image collection apparatus, etc. are the same, respective colors of areas of the hillocks and areas of normal surface of the metal layer in different optical images should also be the same. Hence, if a certain adjustment mode for the brightness and contrast is suitable for one optical image, the adjustment mode should also be suitable for other optical images. Thus, correct and feasible adjustment values (e.g., 25% increase in brightness, 20% increase in contrast, etc.) for the brightness and contrast may be respectively determined through pre-tests, so that in step S102, the contrast and brightness of all of the optical images are respectively adjusted according to a predetermined brightness adjustment value and a predetermined contrast adjustment value, thus simplifying process and improving efficiency.

Step 103 includes converting the adjusted optical image into a black-and-white image.

Obviously, the optical image obtained in step S102 is an image having grayscale and color information. To facilitate subsequent processing, the optical image (having been subjected to brightness and contrast adjustment) should be converted into a black-and-white image through the MATLAB or other software in this step. For example, FIG. 4 is a black-and-white image obtained by converting the optical image in FIG. 3.

Optionally, after step S103, the method for detecting a hillock in a metal layer further includes: step S104 of determining whether a black pixel in the black-and-white image corresponds to an area of a hillock in the optical image; if not, returning to the step of adjusting contrast and brightness of the optical image (i.e., step S102); if yes, proceeding to step S105.

As shown in FIG. 4, in the black-and-white image obtained by conversion, black pixels in the black-and-white image should correspond to areas of hillocks in the optical image. In the process of the above conversion, however, if the adjustment of the brightness, the contrast or the like is not appropriate, it is possible that the black pixels in the converted black-and-white image do not correspond to actual hillocks (e.g., a part of areas of the hillocks in the optical image are converted into white pixels, or a part of areas of the normal surface of the metal layer in the optical image are converted into black pixels), which deteriorates the detection result. Thus, after conversion, the black-and-white image and the optical image are compared; it is artificially determined whether or not the black pixels in the black-and-white image correspond to the area of the hillocks in the optical image; if not, the method returns to the above step of adjusting contrast and brightness of the optical image (i.e., step S102) to select a different adjustment value to reprocess the optical image.

Needless to say, in the cases where it is determined that the converted black pixels are bound to correspond to the hillocks (for example, under the condition that other conditions remain unchanged, the predetermined adjustment values are adopted in step S102), step S104 may be omitted.

Step S105 includes determining a black pixel in the black-and-white image as a spot of a corresponding hillock.

The black-and-white image obtained by conversion as shown in FIG. 4 is analyzed. At this time, areas of the hillocks in the optical image should have been converted into black pixels, and areas of normal surface of the metal layer should have been converted into white pixels.

Optionally, the method for detecting a hillock in a metal layer further includes calculating a ratio of the number of black pixels to a total number of pixels in the black-and-white image, and determining hillock condition in the metal layer based on the ratio.

In general, the most important parameter representing the hillock condition is the area occupied by the hillocks. According to the method of the embodiments, because hillocks correspond to black pixels, the proportion of the black pixels in all of the pixels indicates a proportion of the area occupied by the hillocks, and in this way, the required parameter can be obtained easily.

After the above detection, it may be determined whether the product is qualified based on the detection result; alternatively, the detection result may be analyzed to further study the causes of occurrence of hillocks or the like, to provide the basis for the improvement of the process.

It can be seen that in the method for detecting a hillock in a metal layer in the embodiments of the present disclosure, hillock condition in the metal layer can be acquired only by directly collecting the optical image of the metal layer using the existing apparatus in the production line and performing simple analysis processing on the optical image, without complex operations such as substrate slicing, transparent paper labeling, scanning and the like. Thus, the method has high efficiency, takes only several hours to be finished, and can be used in the actual production process.

In another aspect, embodiments of the present disclosure further provide a device for detecting a hillock in a metal layer, which is used for performing the above method for detecting a hillock in a metal layer.

Specifically, the device for detecting a hillock in a metal layer according to the embodiments of the present disclosure includes:

a collector, configured to collect an optical image of the metal layer;

an adjuster, configured to adjust contrast and brightness of the optical image;

a converter, configured to convert the adjusted optical image into a black-and-white image; and

an analyzer, configured to determine a black pixel in the black-and-white image as a spot of a corresponding hillock.

In some embodiments, the adjuster is configured to increase the contrast and brightness of the optical image. In some embodiments, the adjuster is configured to:

adjust the contrast of the optical image according to a predetermined contrast adjustment value; and adjust the brightness of the optical image according to a predetermined brightness adjustment value. In some embodiments, the analyzer is further configured to calculate a ratio of the number of black pixels to a total number of pixels in the black-and-white image, and determine hillock condition in the metal layer based on the ratio.

The device for detecting a hillock in a metal layer according to the embodiments of the present disclosure includes elements for implementing the steps in the above method for detecting a hillock in a metal layer, and thus can perform the above method for detecting a hillock in a metal layer.

It can be understood that, the above implementations are merely exemplary implementations used for explaining the principle of the present disclosure, but the present disclosure is not limited thereto. For those skilled in the art, various modifications and improvements may be made without departing from the spirit and essence of the present disclosure, and these modifications and improvements are also deemed as falling within the protection scope of the present disclosure.

1. A method for detecting a hillock in a metal layer, comprising:
collecting an optical image of the metal layer;
adjusting contrast and brightness of the optical image to obtain an adjusted optical image;
converting the adjusted optical image into a black-and-white image; and
determining a black pixel in the black-and-white image as a spot of a corresponding hillock.

2. The method of claim 1, wherein,
the metal layer is a layer formed of a pure metal.

3. The method of claim 2, wherein,
the layer formed of a pure metal is a pure aluminum layer.

4. The method of claim 2, wherein,
the layer formed of a pure metal is a pure copper layer.

5. The method of claim 1, wherein,
the optical image is an enlarged optical image.

6. The method of claim 5, wherein,
the enlarged optical image is collected by a Micro-Macro defect checker.

7. The method of claim 1, wherein, the step of adjusting contrast and brightness of the optical image comprises:
increasing the contrast and brightness of the optical image.

8. The method of claim 1, wherein, the step of adjusting contrast and brightness of the optical image comprises:
adjusting the contrast of the optical image according to a predetermined contrast adjustment value; and
adjusting the brightness of the optical image according to a predetermined brightness adjustment value.

9. The method of claim 1, wherein, after the step of converting the adjusted optical image into the black-and-white image, the method further comprises:
determining whether the black pixel in the black-and-white image corresponds to a hillock in the optical image, and if it is determined that the black pixel in the black-and-white image does not correspond to a hillock in the optical image, returning to the step of adjusting contrast and brightness of the optical image.

10. The method of claim 1, further comprising:
calculating a ratio of the number of black pixels to a total number of pixels in the black-and-white image, and determining hillock condition in the metal layer based on the ratio.

11. A device for detecting a hillock in a metal layer, comprising:
a collector, configured to collect an optical image of the metal layer;
an adjuster, configured to adjust contrast and brightness of the optical image to obtain an adjusted optical image;
a converter, configured to convert the adjusted optical image into a black-and-white image; and
an analyzer, configured to determine a black pixel in the black-and-white image as a spot of a corresponding hillock.

12. The device of claim 11, wherein,
the metal layer is a layer formed of a pure metal.

13. The device of claim 12, wherein,
the layer formed of a pure metal is a pure aluminum layer.

14. The device of claim 12, wherein,
the layer formed of a pure metal is a pure copper layer.

15. The device of claim 11, wherein,
the optical image is an enlarged optical image.

16. The device of claim 15, wherein,
the enlarged optical image is collected by a Micro-Macro defect checker.

17. The device of claim 11, wherein,
the adjuster is configured to increase the contrast and brightness of the optical image.

18. The device of claim 11, wherein,
the adjuster is configured to
adjust the contrast of the optical image according to a predetermined contrast adjustment value; and
adjust the brightness of the optical image according to a predetermined brightness adjustment value.

19. The device of claim 11, wherein,
the analyzer is further configured to calculate a ratio of the number of black pixels to a total number of pixels in the black-and-white image, and determine hillock condition in the metal layer based on the ratio.
